(19) United States
(12) Patent Application Publication
(10) Pub. No.: US 2006/0235870 A1
(43) Pub. Date: Oct. 19, 2006

(54) System and method for generating an interlinked taxonomy structure

(75) Inventor: Timothy A. Musgrove, San Francisco, CA (US)

Correspondence Address: NIXON PEABODY, LLP, 401 9TH STREET, NW, SUITE 900, WASHINGTON, DC, 20004-2128, US

(73) Assignee: Musgrove Technology Enterprises, LLC, Morgan Hill, CA (US)

(21) Appl. No.: 11/343,083

(22) Filed: Jan. 31, 2006

Related U.S. Application Data
(60) Provisional application No. 60/647,767, filed on Jan. 31, 2005.

(51) Int. Cl. G06F 7/00

(52) U.S. Cl. 707/102

(57) ABSTRACT

A system and method for interlinking differing taxonomies, the system including a communications module that provides access to corpora having electronic documents categorized in accordance with first and second taxonomies with a plurality of nodes. The system also includes an analysis module that analyzes the nodes of the first taxonomy, the nodes of the second taxonomy, and at least one of the first plurality of electronic documents and the second plurality of documents, to identify nodes of the second taxonomy that correspond to nodes of the first taxonomy. A processor generates an interlinked taxonomy structure with a plurality of links interlinking together nodes of the first and second taxonomies identified to be related to each other, while also providing informative glosses of each node.

This application claims priority to U.S. Provisional Application No. 60/647,767, filed Jan. 31, 2005, the contents of which are incorporated herein by reference.

### BACKGROUND OF THE INVENTION

1. Field of the Invention

The present invention is directed to a system and method for interlinking differing taxonomies of corpora.

2. Description of Related Art

Large corpora of electronic documents exist in a number of contexts. The Internet is a common platform for accessing such electronic document. Various types of tools are provided for organizing and extracting information from such corpora of electronic documents. Such tools that are used for organizing or extracting information from the corpora can be generally classified as text based tools, fact based tools, and concept based tools. Example formats of text base tools include alphabetical index with page numbers at the back of a book; similar indices on websites; full-text search engines; keyword-based news-clipping services; and the web browser itself (users simply browsing content manually to identify relevant information). Such text based tools are commonly implemented, for example, by Google®, Yahoo®, Search.com®, and Dictionary.com®, etc.

Example formats of fact based tools include user lookups in tables of facts and figures; real-time streaming displays of numerical measures; and tabular forms that a user fills out to retrieve matching information from a discrete database. Such fact based tools are implemented, for example, by Yahoo® Weather (based on zip code entry); Wall Street Journal's® online streaming stock-quote utility; National Football League's® player rosters with play statistics; and Equifax® credit report ordering form, etc.

Example formats of concept based tools include topical taxonomies for navigation of websites; taxonomies for FAQs (Frequently Asked Questions); and taxonomies for Guides or “Wizards” in Help environments. Such concept based tools are exemplified by Yahoo® Topic Menu having glosses of each topic, for instance, by the entries in Wickipedia.com® and other encyclopedic types of websites, or by the web-based questionnaire that users are asked to fill out in the automated technical support (or “trouble-shooting”) section of the websites of major electronics manufacturers such as Hewlett-Packard®. It is relevant to note that these concept-based tools have in common, the use of some form of taxonomy, i.e. a largely hierarchical organization of entities and/or events, as the basis of their information architecture. Correspondingly, such tools can be referred to as “taxonomy-driven” tools.

Depending on the type of inquiry being made to organize or extract information from the electronic documents of a corpus (i.e. whether the inquiry is general, particular, thematic, or idiosyncratic), one category of tool will likely be more appropriate than another category. However, concept based tools are foundational in almost all types of inquiry, except for the idiosyncratic inquiries concerning particular objects. Thus, because of their importance, the concept-based tools, are of significant interest for anyone attempting to develop, or to make more accessible, the large corpus of electronic documents.

However, in the current state-of-the-art, general-purpose concept-based tools are severely constrained and limited, both in their coverage (i.e. for any single tool, there is usually an insufficient variety and number of content items included in its scope), and in their robustness (i.e. for any given tool there is usually an insufficient depth and breadth of concepts grasped by the system). Although there is a vast number of different taxonomies for various corpora of electronic documents, such tools do not have the same structure, and essentially operate independent of one another.

The reason that concept-based tools are limited in coverage and depth is because they are conceptual, and consequently, it is difficult to give them coverage and depth. This implies conceptual analysis in their design and implementation which is difficult. An example of such difficulty is exhibited in trying to conceptually define a simple object such as a chair. Nearly every definition proposed for the chair is either too broad or too narrow. Correspondingly, the disparate concept based tools including disparate taxonomies are presently used and available reflect disparate conceptual schemata in separate, or substantially independent, information corpora.

It may theoretically be possible to construct one “ultimate taxonomy” that would encompass all of the different taxonomies of the different corpora. However, even if such a taxonomy is possible, which is highly unlikely, creating such a taxonomy would be extremely difficult, if not practically impossible. The reality is that presently, very many electronic documents are being classified daily by very many different editors using very many different taxonomies. These taxonomies themselves are being expanded, corrected, and revised all the time. Absorbing all of them into a single taxonomy is, to say the least, far less practical than simply allowing them to exist and be used.

Therefore, there exists an unfulfilled need for a system and method for improving concept based tools such as taxonomies for organizing and extracting information from a plurality of corpora. In particular, there exists an unfulfilled need for such a system and method that increases the usability and efficacy of the disparate taxonomies.

### SUMMARY OF THE INVENTION

As explained in further detail below, the present invention allows for concept based tools to directly reflect, preserve, and embrace the plurality and the incompleteness of the taxonomies in use. In particular, the present invention provides a system and method for connecting the plurality of taxonomies together so as to allow the user or editor to inter-relate, inter-operate, and inter-navigate the various taxonomies in an efficient manner.

In view of the foregoing, an advantage of the present invention is in providing a system and method for efficient organization of electronic documents from a plurality of corpora.

Another advantage of the present invention is in providing a system and method for increasing depth and breadth of taxonomies and information provided thereby.

Still another advantage of the present invention is in providing a system and method that interlinks a plurality of taxonomies together.

In accordance with one aspect of the present invention, a system for interlinking differing taxonomies is provided. In one embodiment, the system includes a communications module that provides access to a first corpus having a first plurality of electronic documents categorized in accordance with a first taxonomy with a plurality of nodes, and a second corpus having a second plurality of electronic documents categorized in accordance with a second taxonomy with a plurality of nodes. The system also includes an analysis module that analyzes the nodes of the first taxonomy, the nodes of the second taxonomy, and at least one of the first plurality of electronic documents and the second plurality of documents, to identify nodes of the second taxonomy that correspond to nodes of the first taxonomy. In addition, the system also includes a processor that generates an interlinked taxonomy structure with a plurality of links interlinking together nodes of the first and second taxonomies identified to be related to each other. The first corpus and second corpus may be websites, and the first and second plurality of electronic documents may be webpages of the websites.

The analysis module may be implemented to compare electronic documents classified in the nodes of the first taxonomy to electronic documents classified in the nodes of the second taxonomy. Alternatively, or in addition thereto, the analysis module may be implemented to determine whether electronic documents classified in the nodes of the first taxonomy is present in the nodes of the second taxonomy. Furthermore, the analysis module may be implemented to determine whether electronic documents classified in the nodes of the second taxonomy is present in the nodes of the first taxonomy.

In accordance with another embodiment, the taxonomy interlinking system further includes a semantic resemblance module that allows the analysis module to compare names of the nodes of the first taxonomy to names of the nodes of the second taxonomy to identify related node names. In accordance with another embodiment, the semantic resemblance module further allows the analysis module to compare text of the electronic documents classified under the nodes of the first taxonomy to text of the electronic documents classified under the nodes of the second taxonomy to identify related electronic documents.

In still another embodiment, the taxonomy interlinking system further includes a clustering module that clusters related electronic documents classified in accordance with the first taxonomy, and clusters related electronic documents classified in accordance with the second taxonomy. In one implementation, the clustering module determines relatedness scores between electronic documents of the first and second plurality of electronic documents which is indicative of degree to which identified documents are related to each other. Preferably, the clustering module anchors together related electronic documents classified in accordance with the first taxonomy with the electronic documents classified in accordance with the second taxonomy that have a predetermined relatedness score to closely associate the anchored electronic documents. In addition, the clustering module tethers together, electronic documents related to an anchored electronic document and having a relatedness score lower than the predetermined relatedness score, to the anchored electronic document to loosely associate the tethered electronic documents with the anchored electronic document.

In accordance with another aspect of the present invention, a method for interlinking differing taxonomies is provided. In accordance with one embodiment, the method includes accessing a first corpus having a first plurality of electronic documents categorized in accordance with a first taxonomy with a plurality of nodes, and accessing a second corpus having a second plurality of electronic documents categorized in accordance with a second taxonomy with a plurality of nodes. The method also includes analyzing the nodes of the first taxonomy, the nodes of the second taxonomy, and at least one of the first plurality of electronic documents and the second plurality of documents, to identify nodes of the second taxonomy that correspond to nodes of the first taxonomy. In addition, the method further includes interlinking together the identified nodes of the second taxonomy and the identified nodes of the first taxonomy that correspond with each other.

In accordance with yet another aspect of the present invention, a computer readable medium is provided with executable instructions for implementing the above describe system and/or method.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIG. 1 is a schematic illustration of a taxonomy interlinking system in accordance with one embodiment of the present invention.

FIG. 2 is an illustration of an example interlinked taxonomy structure generated by the taxonomy interlinking system shown in FIG. 1.

FIG. 3 is a screen shot of an example implementation of the clustering module.

FIG. 4 is a schematic diagram illustrating divergence between two different taxonomies.

FIG. 5 is a schematic flow diagram of the method in accordance with one embodiment of the present invention.

### DETAILED DESCRIPTION OF THE PREFERRED EMBODIMENT

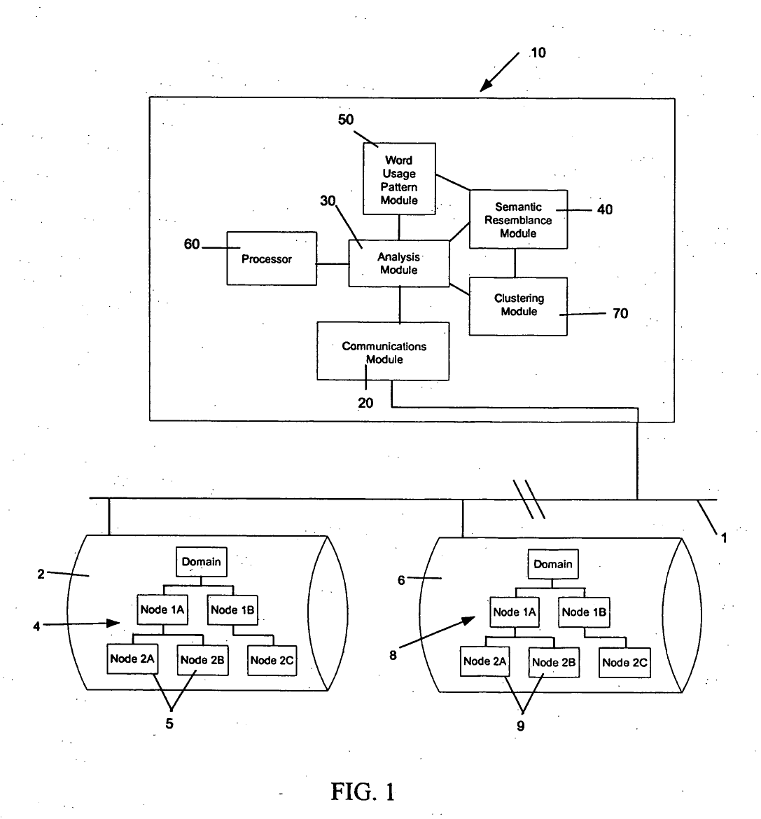

FIG. 1 illustrates a schematic view of a taxonomy interlinking system 10 in accordance with one embodiment of the present invention for interlinking differing taxonomies of corpora that have a plurality of electronic documents. It should initially be understood that the taxonomy interlinking system 10 of FIG. 1 may be implemented with any type of hardware and/or software, and may be a pre-programmed general purpose computing device. For example, the taxonomy interlinking system 10 may be implemented using a server, a personal computer, a portable computer, a thin client, or any suitable device or devices. The taxonomy interlinking system 10 and/or components thereof may be a single device at a single location or multiple devices at a single, or multiple, locations that are connected together using any appropriate communication protocols over any communication medium such as electric cable, fiber optic cable, or in a wireless manner.

It should also be noted that the taxonomy interlinking system 10 in accordance with the present invention is illustrated and discussed herein as having a plurality of modules which perform particular functions. It should be understood that these modules are merely schematically illustrated based on their function for clarity purposes only, and do not necessary represent specific hardware or software. In this regard, these modules may be hardware and/or software implemented to substantially perform the particular functions discussed. Moreover, the modules may be combined together within the taxonomy interlinking system 10, or divided into additional modules based on the particular function desired. Thus, the present invention, as schematically embodied in FIG. 1, should not be construed to limit the taxonomy interlinking system 10 of the present invention, but merely be understood to schematically illustrate one example implementation thereof.

Utilizing the taxonomy interlinking system 10 of the present invention presumes pre-existing taxonomies with a plurality of nodes, a plurality of electronic documents being classified under these nodes. As used herein, “taxonomy” should be understood to be synonymous with “subject index” in information science or informatics. Moreover, the term “electronic document” refers to any computer readable file, regardless of format and/or length. For instance, web pages of websites, word processing documents, presentation documents, spreadsheet documents, PDF documents, etc. are all examples of electronic documents referred to herein. In this regard, the method in accordance with the present invention as explained hereinbelow can be applied to any appropriate electronic document that can be classified under a taxonomy based classification schema.

The taxonomy interlinking system 10 in accordance with the illustrated embodiment of FIG. 1 includes a communications module 20 that provides access to a first corpus 2 having a first plurality of electronic documents categorized in accordance with a first taxonomy 4 including a plurality of nodes 5 as known in the art. The communication module 20 also provides access to a second corpus 6 having a second plurality of electronic documents categorized in accordance with a second taxonomy 8 including a plurality of nodes 9 as also known in the art.

In the illustrated embodiment, the communications module 20 connects the taxonomy interlinking system 10 to the first and second corpora via a network such as the Internet 1 as shown. It should be appreciated that as shown in FIG. 1, the first corpus 2 and the second corpus 6 are not actually components of the taxonomy interlinking system 10, but rather, are components that are interlinked by the taxonomy interlinking system 10 of the present invention in the manner described below.

As shown, the taxonomy interlinking system 10 in accordance with the illustrated embodiment includes an analysis module 30 that analyzes the nodes of the first taxonomy 4 and the first plurality of electronic documents classified therein, as well as the nodes of the second taxonomy 8 and the second plurality of documents classified therein. The analysis performed by the analysis module 30 results in identification of a plurality of nodes of the second taxonomy 8 that correspond to the plurality of nodes of the first taxonomy 4 so that these corresponding nodes can be interlinked together.

Preferably, the analysis module 30 determines whether nodes correspond to one another based on semantic resemblance analysis executed by a semantic resemblance module 40 that is provided in the taxonomy interlinking system 10. The semantic resemblance module 40 analyzes the names of the nodes, and the words of the electronic documents classified under these nodes, to provide information as to the strength, or weakness, of the correlation between the nodes and/or documents so that nodes having strong correlation can be identified and interlinked together. The semantic analysis information as determined by the semantic resemblance module 40 is preferably quantified, for example, as a semantic resemblance score.

In this regard, the taxonomy interlinking system 10 of the illustrated embodiment is further provided with word usage pattern module 50 that allows the node names and the texts of the electronic documents to be analyzed based on how the words are used in context, rather than merely analyzing the text based on definitions of the words. In particular, the taxonomy interlinking system 10 utilizes the semantic resemblance module 70 and the word usage pattern module 50 to extract and compare a vector of semantic features. Such semantic features include, but are not limited to: the most common phrases in which each word occurs; the synonyms, hypernyms, and hyponyms present in the surrounding context of each such word occurrence; features of the grammatical constructions in which each word occurs (such as relations of nouns to verbs as variously an actor, object, instrument, or other semantic role); the appearance of a word as part of a proper name versus occurring generically; other contextual semantic features that the taxonomy interlinking system 10 observes to differentiate a particular word's pattern of occurrences in one plurality of electronic documents (or portions thereof), from its pattern of occurrences in another plurality of electronic documents (or portions thereof).

The analysis module 30 is preferably implemented to utilize metrics such as correlation scores to quantify the strength of the correlation between the nodes, which can then be used as a basis for determining whether particular nodes of differing taxonomies should be interconnected. Such correlation scores can incorporate the semantic resemblance score as determined by the semantic resemblance module 40. The semantic resemblance module 40 may be implemented in any appropriate manner based on any appropriate semantic analysis techniques, and may be further provided with various tools that can be used to enhance analysis, as described in further detail below.

The taxonomy interlinking system 10 in accordance with the illustrated embodiment of FIG. 1 further includes a processor 60 that interlinks the nodes of the first taxonomy 4 and the second taxonomy 8 together which have been determined to correspond to each other by the analysis module 30. Thus, the processor 60 generates an interlinked taxonomy structure as described in further detail below, that interconnects the nodes of two (or more) taxonomies.

The above summarized utilization of the taxonomy interlinking system 10 shown in FIG. 1 presumes that the taxonomies already classify many of the same electronic documents as each other. To address those instances where two taxonomies being analyzed do not classify many of the same electronic documents, a clustering module 70 is provided in the preferred embodiment as shown in FIG. 1. The clustering module 70 may be used to group, i.e. classify, the plurality of electronic documents into clusters of electronic documents based on how they relate to one another, for example, using the semantic resemblance module 40. Thus, electronic documents classified under the first taxonomy can be clustered, and the electronic documents classified under the second taxonomy can be clustered by the clustering module 70. These clusters essentially serve as nodes for allowing interlinking of the clusters together. In particular, the clusters of electronic documents in different taxonomies can then be analyzed by the analysis module 30 to identify those clusters of the first and second taxonomies that correspond to one anther. The processor 60 then interlinks the corresponding clusters together to thereby interlink the nodes of the first and second taxonomies together, albeit in a less direct manner.

In view of the brief description of the taxonomy interlinking system 10 set forth above, it should be apparent that the system and method of the present invention “bootstraps” two (or more) taxonomies or classification schemata together. Further detailed discussion of the various modules of the taxonomy interlinking system 10 in accordance with the preferred implementation, as well as the general functions thereof, is discussed herein below.

Communications Module/First and Second Taxonomies

As noted, the communications module 20 of the taxonomy interlinking system 10 provides access to corpora of electronic documents where the electronic documents are classified in accordance with taxonomies. Two or more fairly robust taxonomies, i.e. classification indices, are inter-related together by the taxonomy interlinking system 10 of the present invention to provide an interlinked taxonomy structure. Referring again to FIG. 1, the first taxonomy 4 and the second taxonomy 8 will likely have some partly overlapping names in their respective nodes. This means that the names of the nodes need not be identical, but some will likely be related, for example, have the same root word, are synonyms of each other, or have some other relationship. In addition, the first plurality of electronic documents and the second plurality of electronic documents classified under the nodes of their respective taxonomies preferably also have substantial overlap.

Analysis Module

As noted, the analysis module 30 analyzes the first taxonomy 4 with the first plurality of electronic documents classified thereunder, as well as the second taxonomy 8 wit the second plurality of electronic documents classified thereunder, to identify those nodes that correspond to one another between the two taxonomies. This analysis can be considered to occur in two main phases: candidate selection and candidate validation. As also described in further detail below, semantic resemblance module 40 may be utilized to analyze the names of the nodes and the electronic documents in these phases, to thereby derive important information as to how the different nodes of the different taxonomies relate to one another so that nodes of the first and second taxonomies can be interlinked.

In the candidate selection phase, the analysis module 30 utilizes the semantic resemblance module 40 to analyze the names of the nodes in the first taxonomy 4 and the nodes of the second taxonomy 8 to identify common words between the nodes of the taxonomies. Any appropriate semantic resemblance analysis may be performed to determine whether there are matches between the node names of the first taxonomy 4 and the node names of the second taxonomy 8. This analysis preferably includes stemming the names of the nodes to encompass variations thereof, and to include synonyms (and alternatively, also hypernyms and/or hyponyms) of words occurring in the names of the nodes. Thus, candidate nodes with corresponding node names are identified. Of course, such analysis will likely result in a number of false positives where the identified nodes are not really related at all even though they may use the same, or similar words in their respective node names. Such bad candidates are eliminated later in the candidate validation phase as described below.

In addition, the analysis module 30 analyzes each node of the first taxonomy 4 to identify the electronic documents that are classified under each node. Then, initially presuming that the first taxonomy 4 and the second taxonomy 8 classify some of the same electronic documents as each other, the analysis module 30 looks at the electronic documents that are classified under each node of the first taxonomy 4, and looks for matching electronic documents in the second taxonomy 8 regardless of where these matching electronic documents may be classified in the second taxonomy 8. The analysis module 30 also notes the node of the second taxonomy 8 wherein such matches are found, together with the number of such matches for each node. This may be implemented, for example, by searching for the title of each document classified under the node of the first taxonomy 4 being analyzed, within the second plurality of electronic documents classified under the second taxonomy 8.

Thus, the primary objective of such analysis is to find out which node(s) in the second taxonomy 8 contain electronic documents from the node of the first taxonomy 4 being analyzed. If the analysis module 30 identifies more than a predetermined number of matching electronic documents in a particular node of the second taxonomy 8 (that match electronic documents of the node in the first taxonomy 4 being analyzed), this particular node is also identified as a candidate node. This analysis can be performed for the other nodes of the first taxonomy 4 to identify candidate nodes from the second taxonomy 8.

Analysis tools such as the semantic resemblance module 40 and/or the word usage pattern module 50 may be utilized in the candidate selection analysis. As noted, the semantic analysis information as determined by the semantic resemblance module 40 is preferably quantified, for example, as the semantic resemblance score. It should also be understood that the above analysis allows identification of candidate nodes in the second taxonomy 8 that potentially correspond to the nodes of the first taxonomy 4, whether their particular node names identically match or not. In addition, it should also be understood that more than one node of the second taxonomy 8 can be identified as a candidate node for matching with a node of the first taxonomy 4, because the second taxonomy 8 may redundantly classify many electronic documents, diversely classify them with respect to the first index, or be malformed with having two redundant nodes where the same electronic documents are classified.

In the candidate validation phase, the analysis module 30 further analyzes the identified matching nodes in detail (node of the first taxonomy 4 and candidate node(s) of the second taxonomy 8 found to be matching) to determine if the matches are, in fact, valid matches. The analysis module 30 first seeks validation of the identified candidate nodes of the second taxonomy 8 by extending the scope of the analysis performed in identifying candidate nodes. In particular, the analysis module 30 utilizes the semantic resemblance module 40 to analyze names of the identified matching nodes using stemming, and hypernym trees in Wordnet, etc. However, this analysis also preferably includes the names of the parent and child nodes in the first and second taxonomies, such that if a word in the name of a node is found in an ancestral or descendant node, it also counts as a match. In this regard, the following taxonomy structure illustrates matching nodes when ancestral and descendant nodes are taken into consideration:

Top|Sports|Archery|Archery Clubs & Organizations

Top|Sports|Societies & Organizations|Archery

Top|Sports|Archery|Clubs

In addition, the analysis module 30 searches for the electronic documents classified under the node of the first taxonomy 4 being analyzed to see if they are found in, or in close relation to, each identified candidate node(s) of the second taxonomy 8. In this regard, the occurrences of matching electronic documents in a child or cross-referenced node in the second taxonomy 8 are also considered as matches. Furthermore, the analysis module 30 may be implemented to keep track of negative confirmation, i.e. that a particular electronic document of the node of the first taxonomy 4 is not found in another node of the second taxonomy 8 which is not related to the candidate node(s). Conversely, the analysis module 30 may be implemented to check each electronic document in the identified candidate node of the second taxonomy 8 that it is in, or in close relation to, the node of the first taxonomy 4 being analyzed, and is not found in an unrelated node in first taxonomy 4. The results of the above analysis in the validation phase may be quantified, for example, as an extension score, for the matching nodes of the first and second taxonomies.

In the preferred embodiment of the taxonomy interlinking system 10, the semantic resemblance score is weighed in with the extension score to result in the final correlation score for each of the matching nodes of the first taxonomy 4 and the second taxonomy 8. In the illustrated implementation, if the final correlation score meets a predetermined required correlation score, the particular matching nodes are interlinked together, whereas if the final correlation score fails to meet the predetermined required score, the particular matching nodes are not interlinked together.

Preferably, the user of the taxonomy interlinking system 10 is allowed to select the respective weighting of the scores, and is also allowed to select the predetermined final correlation score that is required for a particular match between nodes to be considered valid for interlinking by the processor 60. Correspondingly, the user of the taxonomy interlinking system 10 is provided with substantial control in defining what constitutes a match for interlinking. Of course, in other embodiments of the present invention, such user selectivity can be automated with fixed weighting values and fixed final correlation score so as to substantially remove the need for user input. However, as can be readily appreciated, allowing such user control over these parameters increases the flexibility and utility of the taxonomy interlinking system 10.

Processor/Interlinked Taxonomy Structure

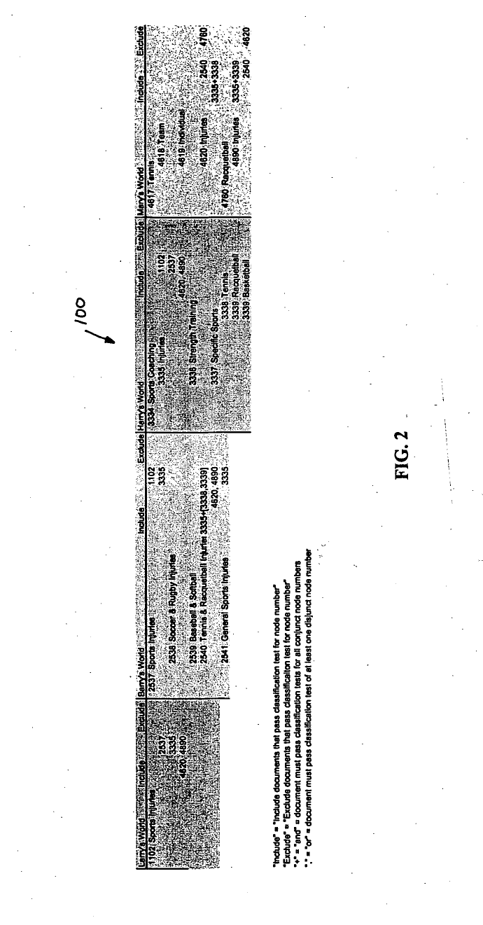

FIG. 2 shows a portion of an interlinked taxonomy structure 100 that is generated by the processor 60 of the present invention. In the interlinked taxonomy structure 100, example nodes of four different taxonomies (Larry's World, Barry's World, Harry's World, and Mary's World) related to the domain of sports have been interlinked utilizing the taxonomy interlinking system 10 shown in FIG. 1. Thus, various nodes of taxonomies (e.g. Larry's, Barry's) which are related to each other have been identified and interlinked together in accordance with the present invention. The interlinked taxonomy structure 100 of FIG. 2 demonstrates that many-to-many interlinking of a plurality of taxonomies can be attained. Of course, interlinking of one or more taxonomies to a single taxonomy, such as a master taxonomy, can also be readily attained.

Thus, referring again to FIG. 2, in the taxonomy named Larry's World, node 1102 named Sports Injuries is linked to various nodes of other taxonomies. In particular, node 1102 is linked to: node 2537 of the taxonomy named Barry's World; node 3335 of the taxonomy named Harry's World; and nodes 4620 and 4890 of the taxonomy named Mary's World. In a similar manner, node 2537 named Sports Injuries of Barry's World taxonomy is linked to: node 1102; and node 3335 of different taxonomies. In addition, the child node 2540 of node 2537 is further linked to nodes 3335+[3338, 3339]; node 4620; and node 4890. The node 2540 Tennis & Racquetball Injuries is linked to nodes 3335+[3338,3339] which means that node 2540 is interlinked to the union of both node 3335 AND (either node 3338 or node 3339). The other taxonomies Harry's World and Mary's World are also interlinked with each other and the taxonomies Larry's World and Barry's World in the manner shown in the interlinked taxonomy structure 100 of FIG. 2.

The significant advantage of the interlinked taxonomy structure 100 over conventional taxonomy structures is that it essentially provides a taxonomy structure that has much more breadth and depth of information since information sources found in all of the interlinked taxonomies are available for use. In addition, another significant advantage is that such a structure can be developed without all of the labor that is otherwise required to conceptually formulate how various nodes differ from each other, for example, how racquetball differs from tennis. Thus, building of a huge logical representation of everyday or specialized knowledge is avoided, the taxonomy interlinking system 10 of the present invention allowing one to define the required parameters for interlinking nodes of different taxonomies together by merely defining at a general level, what constitutes a sufficient “match” between the nodes and/or electronic documents.

Semantic Resemblance Module

As noted above, the analysis module 30 analyzes the identified matching nodes (node and candidate node) as well as the documents of these nodes, to ultimately determine if the node matches are valid and to interlink such valid matches. In this regard, in the preferred embodiment, the analysis module determines what constitutes a match by invoking the semantic resemblance module 40 that performs semantic resemblance analysis.

The semantic resemblance module 40 may be implemented to determine how one or more words are used, for instance, where the word is used (e.g. Domain and Document Object Model); who uses the word (e.g. Source typing); when the word is used (e.g. situation and context); what words are used with it (e.g. Object, actor, and other thematic roles); and/or force in which the word is used (e.g. exclamation, interrogative, in quotes, with qualifiers, with superlatives, with specific adjectives or adverbs, etc.).

For instance, the semantic resemblance module 40 may be implemented to consider the source of the plurality of documents, i.e. the first corpus 2 and the second corpus 6, in determining the likelihood that the words being analyzed are related to one another. If the corpora are websites and the documents are web pages, website domain information may be used as additional source of information to determine relatedness of the words of the nodes or documents of the taxonomies. The source-types on the Internet are first related to first-level domains, such as org for organizations, .com for the commercial sector, .edu for the academic sector, .gov for the government sector, and so on. However, this level of information is limited in that sources of electronic documents in the first-level domain vary widely. For example, law offices maintain websites with “.com” first-level domain and have electronic documents, i.e. web pages, that address tax law, and therefore, may provide similar information as government sites having the “.gov” first-level domain that address tax law. Therefore, the source-type information may include other parameters, for example, as indicated in the following TABLE 1:

TABLE 1

| Source-type attribute | Possible values |
|---|---|
| First-level domain | .GOV, .COM, .EDU, .ORG, etc. |
| Sector affiliation | Educational, Legal, Medical, Durables, |
| | Consumables, Services, etc. |
| Voice | Conservative, Liberal, Moderate, |
| | Journalistic, Editorial, Comedic |
| Professional level | Professional, Semi-professional (top- |
| | tier blogs), Amateur, Professor, |
| | Graduate Student/Post-Doc, Student |

In addition, the semantic resemblance module 40 may be implemented to consider the stylistic attributes of the electronic documents in determining whether a particular electronic document of the first taxonomy 4 matches another electronic document of the second taxonomy 8 during the candidate validation phase of the analysis performed by the analysis module 30. Examples are shown in TABLE 2 below:

TABLE 2

| Stylistic attribute | Possible values |
|---|---|
| Rhetorical style | Analytic, speculative, rhetorical, |
| | polemical |
| Formal style | Formal, informal, colloquial, vulgar |
| Dialogue style | Closed, Selectively open, Dynamically |
| | open |

In addition, the semantic resemblance module 40 of the present invention may be implemented to consider proper names such as brand names, organization names, company names, etc., as clues to classification of documents pertaining to such named entities. For example, if a node name or a document mentions Harvard®, Princeton®, and/or Yale®, it is likely that the document pertains to education. A document mentioning Merrill-Lynch® and/or Charles Schwab®, is likely to pertain to investments, etc. While not all names can themselves be clues to their own domain, some of them can. Thus, such information can be used to determine the extent to which a particular electronic document of the first taxonomy 4 corresponds to another electronic document of the second taxonomy 8, for example, during the candidate validation analysis.

In addition to the above, in accordance with one implementation, the semantic resemblance module 40 may be implemented to distinguish between the word meaning and the probable speaker's (or writer's) meaning in using the word, despite what the word means literally. The most obvious cases of this are typographical errors that chance upon real words of a different meaning, but which are easily rectified in context. For example, consider the sentence:
“After having been to the Colorado Rockies and then to Palm Springs, Jack said he preferred the dessert.”

Despite the last word of the sentence being, lexically, a treat following dinner, most every reader will interpret the author to have meant the arid climate surrounding the city of Palm Springs. This type of occurrence is problematic to word sense disambiguation that is lexically bound, as it represents noisy data. However, the semantic resemblance module 40 of the present invention may be implemented to recognize word usage patterns in conjunction with the word usage pattern module 50 discussed herein, and assign both the “sweet treat” and “arid climate” patterns to each spelling of the word, despite lexical information. Of course, the reason why this is good is that it will result in relevant data being included appropriately where the common misspellings exist, rather than discarding them.

Such an implementation is especially advantageous in those situations where a phrase has a meaning that is not directly correlated to the meaning of the phrase. If such phrases were analyzed semantically at their “face value,” one would arrive at a very different construal than if their usage was analyzed from the perspective of the object, time, manner, place, etc. of the context. For example, the usage pattern for “pro-choice” and “pro-life” will be related to abortion, but with opposite qualities attached. On the direct semantic approach, “pro-choice” would be tied to concepts of volition and intention, “pro-life” to biological metabolism and/or other criteria of existence, and therefore, the two would seem to be unrelated. Thus, as clearly illustrated by the above examples, usage is clearly more informative regarding the real meaning of the words than semantic composition in certain applications, especially when words or phrases are coined in the electronic documents, but not yet canonized in dictionaries and lexicons.

In addition, the semantic resemblance analysis performed by the semantic resemblance module 50 may be implemented to detect synonym assertions. For example, the semantic resemblance module 50 may be implemented to parse for clues to word senses, such as finding phrases like “also called ______”. These clues provides actual synonym candidates for use during the semantic resemblance analysis. This can reveal a plethora of very specific synonyms, such as specialized jargon of various industries. One embodiment of this is for synonymy assertions to be captured in rules defined as Regular Expressions or “RegEx” which is a public domain standard for defining text-matching rules. Another embodiment may utilize templates.

Thus, the semantic resemblance module 40 in accordance with the present invention can be used by the analysis module 30 to analyze the node names and the documents classified under the first and second taxonomies, to allow assignment of semantic scores during the candidate selection phase, and allow assignment of extension scores during the candidate validation phases of analysis by the analysis module 30 as discussed above. By allowing the determination of when there is a match between the names of the nodes and/or words of the documents, further analysis with respect to the correlation between the nodes can be performed as noted with respect to the candidate selection and validation phases.

In one simple implementation, the semantic resemblance module 40 may be implemented to analyze and mark semantically continuous blocks within each document of the second taxonomy during the candidate selection phase, and measure both, how many blocks in the candidate document are highly similar, and how many are highly non-similar to blocks in the reference documents classified under the node of the first taxonomy. When numbers of similar blocks and non-similar blocks are high, the candidate document is judged to be relevant to a particular node being analyzed, but a non-member of the node. Of course, the above implementation is merely described as one example and the present invention may be implemented differently.

Referring to the above example, consider an electronic document of a candidate node regarding soccer injuries that is compared against a node that classifies soccer coaching documents. One would expect many blocks of text in the electronic document of the second taxonomy to have a lot of semantic resemblance to many blocks of text in the reference documents of the first taxonomy since soccer related words and phrases will appear in both electronic documents of the two nodes/taxonomies. However, there will also be blocks of text directed to injuries, anatomy, medicine and treatment in the electronic document of the candidate node, which will likely be scarcer in the reference electronic documents classified in the node of the first taxonomy. Likewise, the reference documents classified in the node of the first taxonomy will have many blocks of text directed to offensive and defensive tactics in the game of soccer, which will have no semantic correlates in electronic document of the candidate node. Thus, the semantic resemblance module 40 can determine that a particular document of the second taxonomy is related to the node of the first taxonomy, but also that it does not belong in the particular node.

Correspondingly, the semantic resemblance module 40 in accordance with the present invention can be used by the analysis module 30 to analyze the node names and the documents classified under the first and second taxonomies to determine the semantic and extension scores so that the final correlation scores can be determined. This allows the processor 60 to link, or not link, the identified matching nodes together as also previously discussed.

Word Usage Pattern Module

As noted, the taxonomy interlinking system 10 of the present invention may be implemented with the word usage pattern module 50 to recognize word usage patterns by profiling such patterns so that accurate determination of the meaning of the words and phrases can be made in conjunction with the semantic resemblance module 40 discussed above. It should be noted that the general observation that words have varying usage patterns is widely shared and accepted by those in the artificial intelligence art. In this regard, there exist numerous methods of extracting, detecting, and comparing word usage patterns.

However, in accordance with the preferred implementation, the word usage pattern module 50 is determined by establishing unique semantic and structural orbits around the words to be used in the word usage patterns. The following outline provides a brief overview of the procedure for analyzing the electronic documents to derive the usage patterns of words in accordance with the preferred implementation:
1. Establish a series of concentric “semantic orbits” around each word, to be explained below
2. Establishing within each document where a word occurs, a series of concentric “structural orbits” also to be explained below
3. Analyzing patterns in the content of the structural orbits as they relate to the semantic orbits
4. Utilizing word usage pattern to enhance accuracy in determining whether words match

In establishing a series of semantic orbits (or range of distance) around each word, words more strongly associated with a sense or usage of a word can be allowed to be in a farther structural orbit to each other, and still be deemed as relevant and informative, whereas less closely associated words, i.e. words in a more distant semantic orbit, are deemed relevant only if they are found in a closer structural orbit (i.e. in close proximity) to each other; the converse also being true. Examples of the structural orbit and semantic orbits are illustrated in TABLE 3 below in the order of their respective relative distances as indicated:

TABLE 3

| Structural Orbits (Far to Near) | Semantic Orbits (Near to Far) |
|---|---|
| Header of document repository | Name or title of concept |
| Same document | Paradigmatic concept reference |
| Any section header in document | Alternative concept reference |
| Same section of document | Sub-species of concept |
| Same paragraph of document | Genus of concept |
| Same encapsulated segment of | Essential attribute within concept |
| sentences within a paragraph | |
| Same sentence | Paradigmatic attribute within concept |
| Same encapsulated segment | Formally or materially related concept |
| within a sentence | |
| Same phrase | Causally or Teleologically related |
| | concept |
| Same hyphenated string of | Dialectically related concept |
| words | |
| Same word | Sister concepts, domain concepts |

As can be seen in Table 3, the structural scope of the analysis for a particular word usage patter is broader as the semantic relationship is stronger. Conversely, the analysis for a semantic feature that is more loosely related to the word being analyzed is correspondingly more limited to a closer structural scope so that related words must be found closer to the word being analyzed in the electronic document. For example, for the original word “automobile” being analyzed, the word usage pattern module 50 scans for a semantic feature pertaining to the occurrence of the word “vehicle” whose semantic relationship is very strong to “automobile” (i.e. it being a hypernym), in positions relatively far from the occurrence of the original word “automobile” such as a few paragraphs distant or even in a footnote. However, for the word “fan belt,” which is loosely related to “automobile” (i.e. it is a formally related word rather than a hypernym), the word usage pattern module 50 scans for a semantic feature pertaining to this word only within a close orbit, for example, within the same segment of a sentence where the word “automobile” occurred. The end result of such analysis across a plurality of electronic documents is a plurality of word usage patterns for each word. Then, these word usage patterns can be clustered or grouped together based on their similarity to provide total set of word usage patterns for each given word.

Of course, whereas the above describes the preferred method of determining word usage patterns, other methods of determining word usage patterns could be implemented in other embodiments. However, the word usage pattern module 50 that is implemented in accordance with the above description enhances the performance of the taxonomy interlinking system 10 of the present invention.

Clustering Module

As previously noted, in the event that the two taxonomies do not classify many of the same electronic documents, a clustering module 70 may be used to group the plurality of electronic documents into clusters, and the taxonomy interlinking system 10 be used to interlink the clusters together, thereby interlirking the two (or more) taxonomies together. The clustering module 70 may be implemented with a clustering program, which may be neural net based or genetic algorithm based, etc. Which particular technology based clustering program is used by the clustering module 70 is less important, than the result of having a reliable set of clusters derived from the two taxonomies.

In one preferred embodiment, the clustering module 70 may be implemented to include an anchor-tether clusterer as described in further detail below, to determine whether an anchor can be established across nodes of the two taxonomies, and determine whether most of the electronic documents of the various nodes can be tethered to this anchor. The anchor-tether clusterer differs from other clustering programs and technology in that it establish a subset of documents in each cluster which meet certain parameters as the “anchor”, while a larger set of documents that meet lesser parameters are “tethered” to the anchor documents.

In the above regard, the clustering module 70 determines relatedness scores between electronic documents of the first and second plurality of electronic documents that indicate the degree to which identified documents are related to each other. This relatedness score may be based on, for example, the analysis performed by the semantic resemblance module 40, and may take into consideration, other factors indicating relatedness of the electronic documents.

The clustering module 70 anchors the electronic documents classified in accordance with the first taxonomy, together with the electronic documents classified in accordance with the second taxonomy, that have a predetermined relatedness score, or higher. As used herein, anchoring of documents refer to associating the documents together based on the close relationship or relevancy of the anchored documents to each other, even though they are classified under nodes of different taxonomies. In addition, the clustering module 70 tethers together, those electronic documents related to the anchored electronic documents, but have a relatedness score lower than the predetermined relatedness score. Tethering as used herein, refers to looser association of the electronic documents, i.e. that the tethered documents are related to the anchored document, but to a lesser extent required for them to be anchored together.

In the above regard, the clustering module 70 is preferably implemented to allow the user to adjust the predetermined relatedness score which must be satisfied in order for the electronic document to be an anchor. In addition, the clustering module 70 may further be implemented so that the user can adjust the weightings of the various factors that can be considered in determining the relatedness score.

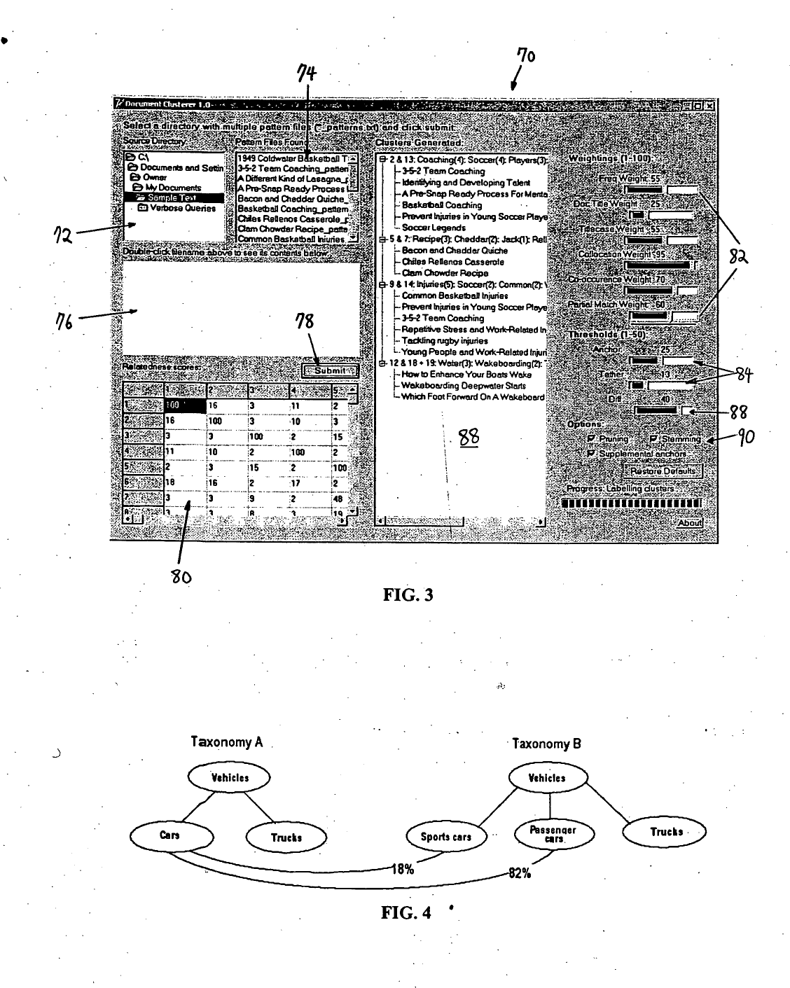

FIG. 3 illustrates a screen shot of an example implementation of the clustering module 70 which is implemented as a computer program. In the illustrated implementation, the clustering module 70 allows the user to select a folder in source directory field 72 where the corpus of electronic documents (i.e. files) to be clustered can be found. A scrollable file list window 74 displays the contents of the selected folder shown in the source directory field 72. Moreover, in the illustrated implementation, file preview window 76 is also provided for allow cursory examination of a file selected from the file list window 74.

Upon clicking of the “Submit” button 78, the clustering module 70 analyzes the electronic documents of the selected folder, and clusters the related electronic documents together using the anchor-tether method described above. In particular, the electronic documents are analyzed to determine how the documents are related to one another, and are assigned a relatedness score. The table 80 lists the document numbers in a matrix, and displays the determined relatedness scores in the corresponding fields. Thus, for instance, the table 80 of the illustrated example screen shot shows that electronic document 1 is perfectly related to electronic document 1 with a relatedness score of 100, as expected. Electronic document 2 is related to electronic document 1 by a relatedness score of 16, while document 7 is related to document 5 by a relatedness score of 48, and so forth.

In the above regard, the clustering module 70 is implemented so that the user can determine the weightings of various factors 82 that contribute to the determination of the relatedness scores. Thus, weightings of the various factors 82 including frequency, document title, title case, collocation, co-occurrence, and partial match, can be adjusted by the user by clicking and dragging the corresponding selection bar. In addition, the clustering module 70 is implemented to allow the user to select the thresholds 84 for the relatedness scores required for electronic documents to be anchored or tethered together. Thus, as shown in the screen shot, the minimum relatedness score for electronic documents to be anchored is set at 25 whereas the minimum relatedness score for electronic documents to be tethered is set at 13.

Since the tethering of documents relaxes the semantic resemblance requirement somewhat, i.e. lowers the threshold required, there is an increased risk of tethering an irrelevant document, as compared to anchoring a document. Such a risk is mitigated by having the clustering module 70 validate each prospective tethering by examining a total semantic “differential” metric, referring to the average semantic difference (i.e. non-resemblance) of a prospectively tethered document to all other tethered documents, and/or the greatest semantic difference (i.e. non-resemblance) of the candidate document to all of the other tethered documents. The degree to which this additional requirement is strictly applied is implemented to also be user adjustable by the “Diff” control bar 88. In additional, further options may be user selected in the present implementation of the clustering module 70 as shown in Options Boxes 90, which in the present implementation, includes pruning, stemming, etc.

The results of the clustering using the anchor-tethering method of the present invention is shown in the clusters window 88. As shown in the illustrated example screen shot, the various electronic documents shown in the file list window 74 have been clustered in the clusters window 88 based on their relevancy to each other. Thus, the first cluster of electronic documents relate to sports, the second cluster of electronic documents relate to food, etc. Referring to the first cluster, documents 2 and 13 are identified as anchored documents for the cluster which means that these documents are closely associated with one another. The remaining documents are tethered to documents 2 and 13 which means that these documents are peripherally related to the anchored documents. Referring to the second cluster, documents 5 and 7 are anchored together. This corresponds to the relatedness score of 48 between these documents (as shown in the table 80) which is higher than the required relatedness score of 25 for anchoring of documents (as shown in threshold 84).

The above described anchor-tether clusterer implemented by the clustering module 70 of the preferred embodiment results in several advantages over conventional methods of clustering and clustering programs in that it provides scalability since tethering new incoming documents to existing anchors can be done quickly and easily, without needing to re-cluster the entire set of electronic documents space. In addition, the described method implemented by the clustering module 70 improves comprehensibility in that the anchor documents provide a core of paradigmatic documents that are representative of the entire cluster, thereby giving the user a starting point for browsing the cluster of documents. Moreover, the existence of anchor provides a means for labeling (i.e. applying a “gloss”) to the cluster, which is not available in clustering methods and clustering programs that do not have such an anchor set of documents. In particular, the gloss of the entire cluster can be constructed as a summary or highlight of the anchor documents themselves, supplemented by a few additional semantic features of the tethered documents. This makes a much more comprehensible gloss than other methods in the art, such as simply listing the most frequent words or phrases in the cluster.

In addition, in accordance with the preferred embodiment, the above described clustering module 70 can be utilized for other purposes as well, for example, by the analysis module 30 in candidate validation phase. In particular, deciding whether two nodes (one in each taxonomy) should be linked together or not, may be determined by the analysis module 30 by instantiating the clustering module 70 to verify that the anchor-tether method is valid across both nodes. In other words, the determination regarding linking of nodes may be made also based on whether the clustering module 70 can anchor an electronic document in the particular node of the fist taxonomy 4 to an electronic document in the identified candidate node of the second taxonomy 8.

If the electronic documents can be anchored across the first and second taxonomies, the clustering module 70 can further attempt to tether a preponderance of the remaining electronic documents in both of the nodes in the two taxonomies to the joint set of anchored electronic documents. If this is found to be attainable as well by the clustering module 70 the analysis module 60 can conclude with high degree of certainty that the two nodes of the first and second taxonomies correspond to each other, and these nodes are interlinked by the processor 60 of the taxonomy interlinking system 10.

In those instances where the two nodes of the first and second taxonomies fail the cross-node anchoring requirement (i.e. no electronic document of the node of the first taxonomy 4 can be anchored to an electronic document of the identified candidate node of the second taxonomy 8), but nonetheless have a large number of tetherable electronic documents, the taxonomy interlinking system 10 of the present invention allows for the recognition that there is an important relatedness between the nodes, despite them not being really the same (and thus, not linkable).

Interlinking of Nodes that is not One-to-One

The above described utilization of the taxonomy interlinking system 10 has been in the context where one-to-one interlinking of nodes in two different taxonomies is attained. However, there are other more subtle forms of interlinking, such as when node 1a corresponds to node 2a minus 2b, i.e. where one node of the first taxonomy 4 corresponds to only a part of a node of the second taxonomy 8. By analyzing the content of the electronic documents themselves using the analysis module 30, the taxonomy interlinking system 10 may be implemented to determine if one of the taxonomies has left undifferentiated, the sub-classes which another, more granular taxonomy, divides out further. In addition, analyzing the content of the electronic documents allows the analysis module 30 to determine if disagreements in classification are simply “noise”, or if they correspond to a disagreement as to which attributes are essential to a node of a taxonomy.

Consider the example shown in FIG. 4 which shows the divergence between the first taxonomy A and the second taxonomy B. In this case, suppose that the classification of documents from “Taxonomy A: Vehicles” to “Taxonomy B: Vehicles” using, for example, the clustering module 70 as a classifier (as explained in further detail below) is near 100%, and from “Taxonomy A: Trucks” to “Taxonomy B: Trucks” is also near 100%, but from “Taxonomy A: Cars” we have the numbers 18% and 82% showing a split between “Taxonomy B: Sports Cars” and “Taxonomy B: Passenger Cars”. This pattern allows detection of divergence of nodes, and suggests that the latter two categories are essentially a more granular separation of the former category. This information can be further used by the analysis module 30 to allow the processor 60 to interlink the appropriate nodes of the two taxonomies, even though there is no direct, one-to-one linking.

Clustering Module as a Classifier

Moreover, the above described clustering module 70 may also be utilized as a classifier to classify electronic documents into nodes of a taxonomy. In particular, the clustering module 70 can be invoked as a classifier to perform the conventional function of a classifying electronic documents into a taxonomy. This may be readily attained by seeding the pre-existing clusters with sample documents chosen by the user so that the clusters essentially represent the various nodes of the target taxonomy. By incrementally clustering new electronic documents to be classified against these pre-seeded clusters which can be considered as nodes of the taxonomy, the clustering module 70 effectively classifies the documents into the taxonomy, despite that it is functioning in the same manner as when it performs ordinary clustering.

The degree of match or relatedness that is required for a particular electronic document to be classified under a particular node/cluster may be controlled by the user. For instance, a threshold for a relatedness score (which may be based on the degree of match based on numerous different parameters) may be set for a node so that the threshold must be satisfied in order for the electronic document to be considered a member of the node and classified there under. Of course, a lower, though still substantive threshold, may be set in order to identify the electronic document as being relevant to the node being analyzed, but not enough to be classified within the node (i.e. not sufficient for membership). Thus, the clustering module 70 can be utilized to classify electronic documents as being relevant, or closely related, or somewhat similar to those in a particular node, even when those electronic documents do not strictly belong in that node.

Referring again to the sample interlinked taxonomy structure 100 shown in FIG. 2, node 2540 Tennis & Racquetball Injuries is linked to nodes 3335+[3338,3339]. In the context where the clustering module 70 is being used as a classifier, this essentially means that node 2540 should be populated with electronic documents that satisfy semantic resemblance analysis of both node 3335 AND (either node 3338 or node 3339). In layman's terms, the rule is essentially saying “to be classified in 2540 you have to be significantly like documents in 3335 and also significantly like documents in either 3338 or 3339.” To apply such rule, the semantic resemblance analysis performed by the semantic resemblance module 40 is preferably fuzzy, or stratified in layers, such that different degrees or different qualities of semantic relatedness can be distinguished.

Of course, the above described taxonomy interlinking system 10 in accordance with the present invention may be implemented to consider any appropriate factor or clues for determining which nodes of the first taxonomy corresponds to node(s) of the second taxonomy. This may be attained utilizing other tools or features that provide deeper and more refined analysis of the relationship between the nodes. Such information can then be used to determine whether nodes of two different taxonomies should be interlinked to each other.

The taxonomy interlinking system 10 of the present invention, components thereof, or the interlinked taxonomy structure derived thereby, may be utilized in various other applications for various purposes as well. For example, the present invention may be utilized to analyze epistemic attributes, to check epistemic coherence, to build non-monotonic knowledge bases, to build a knowledge base based language generator, or to build a question answering tool. For example, the taxonomy interlinking system 10 of the present invention 10 may be utilized to discover and organize frequently asked questions (and answers to them) across electronic documents classified under different taxonomies.

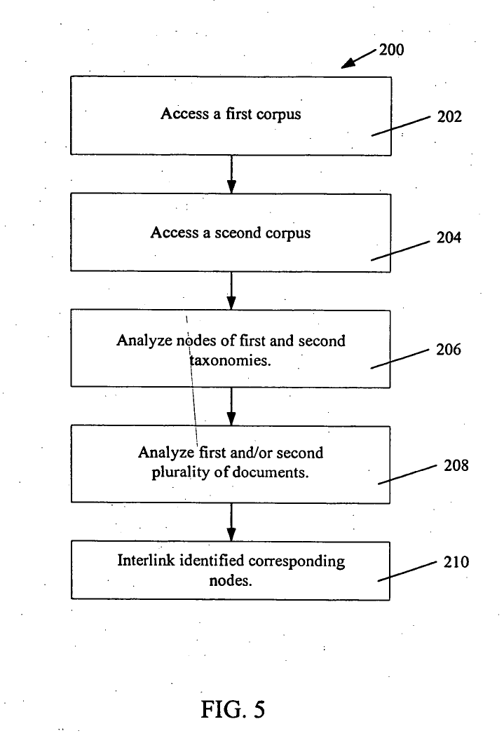

In view of the above, it should be evident that another important aspect of the present invention includes providing a method for interlinking together differing taxonomies. FIG. 5 is a schematic flow diagram 200 of the method in accordance with one embodiment of the present method. In the illustrated embodiment, the method includes accessing a first corpus in step 202, the first corpus having a first plurality of electronic documents categorized in accordance with a first taxonomy with a plurality of nodes, and accessing a second corpus in step 204, the second corpus having a second plurality of electronic documents categorized in accordance with a second taxonomy with a plurality of nodes. The method also includes step 206 where the nodes of the first taxonomy and the nodes of the second taxonomy are analyzed, and in step 208, the first plurality of electronic documents and/or the second plurality of documents are analyzed to identify nodes of the second taxonomy that correspond to nodes of the first taxonomy. In addition, the method further includes step 210 in which the identified nodes of the second taxonomy and the identified nodes of the first taxonomy that correspond with each other are interlinked together.

Moreover, in accordance with yet another aspect of the present invention, a computer readable medium is provided with executable instructions for implementing the above describe system 10 and/or method 200.

As can be appreciated from the discussion above, the taxonomy interlinking system, method, and computer readable medium of the present invention improves the usability and efficacy of the disparate taxonomies by improving the organization and extraction of information from electronic documents of a corpus. In particular, by interlinking nodes of taxonomies together, the present invention allows a user to obtain information from different taxonomies, which may be more relevant than the information available in the particular taxonomy or corpus of documents being searched.

Thus, for example, the present invention allows a user browsing electronic documents classified under one node of a first taxonomy, to browse electronic documents classified under another interlinked node of a second taxonomy. In another example, the present invention allows a search engine to receive a query from a user, and provide search results from multiple corpus of electronic documents in a very efficient manner by the virtue of the interlinked nodes. This is especially advantageous in the search engine context which typically receives a very short query that needs to be analyzed and its domain identified (which is implicitly classifying of the query) in order for the search engine to identify and retrieve relevant electronic documents as search results. Because the query is typically very short, classifiers fail very often to properly classify the query, and as a result, identify an irrelevant node in the taxonomy, thereby retrieving irrelevant documents. However, if a query can be compared against several taxonomies, it is more likely scenario that at least one appropriate classification node will be identified, which, by the virtue of the interlinking, allows identification of other relevant nodes in different taxonomies.

While various embodiments in accordance with the present invention have been shown and described, it is understood that the invention is not limited thereto. The present invention may be changed, modified and further applied by those skilled in the art. Therefore, this invention is not limited to the detail shown and described previously, but also includes all such changes and modifications.

I/We claim:

1. A system for interlinking differing taxonomies comprising:
a communications module that provides access to a first corpus having a first plurality of electronic documents categorized in accordance with a first taxonomy with a plurality of nodes, and a second corpus having a second plurality of electronic documents categorized in accordance with a second taxonomy with a plurality of nodes;
an analysis module that analyzes said nodes of said first taxonomy, said nodes of said second taxonomy, and at least one of said first plurality of electronic documents and said second plurality of documents, to identify nodes of said second taxonomy that correspond to nodes of said first taxonomy; and
a processor that generates a interlinked taxonomy structure with a plurality of links interlinking together nodes of said first and second taxonomies identified to be related to each other.

2. The system of claim 1, wherein said analysis module compares electronic documents classified in said nodes of said first taxonomy to electronic documents classified in said nodes of said second taxonomy.

3. The system of claim 1, wherein said analysis module determines whether electronic documents classified in said nodes of said first taxonomy is present in said nodes of said second taxonomy.

4. The system of claim 1, wherein said analysis module determines whether electronic documents classified in said nodes of said second taxonomy is present in said nodes of said first taxonomy.

5. The system of claim 1, further including a semantic resemblance module that allows said analysis module to compare names of said nodes of said first taxonomy to names of said nodes of said second taxonomy to identify related node names.

6. The system of claim 5, wherein said semantic resemblance module further allows said analysis module to compare text of said electronic documents classified under said nodes of said first taxonomy to text of said electronic documents classified under said nodes of said second taxonomy to identify related electronic documents.

7. The system of claim 6, wherein said semantic resemblance module at least one of:
determines source of said plurality of electronic documents;
determines style of said plurality of electronic documents;
determines usage patterns of words in said plurality of electronic documents;
determines semantic use of words in said plurality of electronic documents;
identifies of synonomy assertion phrases; and
identifies proper nouns in said plurality of electronic documents.

8. The system of claim 1, further including a clustering module that clusters related electronic documents classified in accordance with said first taxonomy, and clusters related electronic documents classified in accordance with said second taxonomy.

9. The system of claim 8, wherein said clustering module determines relatedness scores between electronic documents of said first and second plurality of electronic documents which is indicative of degree to which identified documents are related to each other.

10. The system of claim 9, wherein said clustering module anchors together related electronic documents classified in accordance with said first taxonomy with said electronic documents classified in accordance with said second taxonomy that have a predetermined relatedness score to closely associate said anchored electronic documents.

11. The system of claim 10, wherein said clustering module tethers together, electronic documents related to an anchored electronic document and having a relatedness score lower than said predetermined relatedness score, to said anchored electronic document to loosely associate said tethered electronic documents with said anchored electronic document.

12. The system of claim 1, wherein said first corpus and second corpus are websites.

13. The system of claim 12, wherein said first and second plurality of electronic documents are webpages of said websites.

14. A method for interlinking differing taxonomies comprising:
accessing a first corpus having a first plurality of electronic documents categorized in accordance with a first taxonomy with a plurality of nodes;
accessing a second corpus having a second plurality of electronic documents categorized in accordance with a second taxonomy with a plurality of nodes;
analyzing said nodes of said first taxonomy, said nodes of said second taxonomy, and at least one of said first plurality of electronic documents and said second plurality of documents, to identify nodes of said second taxonomy that correspond to nodes of said first taxonomy; and
interlinking together said identified nodes of said second taxonomy and said identified nodes of said first taxonomy that correspond with each other.

15. The method of claim 14, further including generating a interlinked taxonomy structure with links that interlinks said first and second taxonomies together

16. The method of claim 14, wherein said analyzing includes comparing names of said nodes of said first taxonomy to names of said nodes of said second taxonomy to identify related nodes.

17. The method of claim 14, wherein said analyzing includes comparing electronic documents classified in said nodes of said first taxonomy to electronic documents classified in said nodes of said second taxonomy.

18. The method of claim 17, further including determining whether electronic documents classified in said nodes of said first taxonomy is present in said nodes of said second taxonomy.

19. The method of claim 17, further including determining whether electronic documents classified in said nodes of said second taxonomy is present in said nodes of said first taxonomy.

20. The method of claim 16, further including performing semantic resemblance analysis on at least one of said node names of said first and second taxonomies.

21. The method of claim 20, further including performing semantic resemblance analysis on at least one of said electronic documents classified under said nodes of said first taxonomy and said electronic documents classified under said nodes of said second taxonomy.

22. The method of claim 21, wherein performing semantic resemblance analysis further includes at least one of:
determining a source of said plurality of electronic documents;
determining a style of said plurality of electronic documents;
determining usage patterns of words in said plurality of electronic documents;
determining semantic use of words in said plurality of electronic documents;
identification of synonomy assertion phrases; and
identification of proper nouns in said plurality of electronic documents.

23. The method of claim 14, further including identifying electronic documents from said first and second plurality of electronic documents that are substantially related to each other, and anchoring them together so that said anchored electronic documents are closely associated to one another.

24. The method of claim 23, further including identifying electronic documents from said first and second plurality of electronic documents that are peripherally related to an anchored electronic document, and tethering said peripherally related electronic documents to said anchored electronic document so that said tethered electronic documents are loosely associated to said anchored electronic document.

25. The method of claim 24, wherein identifying related electronic documents includes determining relatedness scores between electronic documents of said first and second plurality of electronic documents which is indicative of degree to which identified documents are related to each other.

26. The method of claim 14, further including clustering related electronic documents classified under nodes of said first taxonomy, and clustering related electronic documents classified in under nodes of said second taxonomy.

27. The method of claim 26, further including anchoring together related electronic documents classified under nodes of said first taxonomy with said electronic documents classified under nodes of said second taxonomy that have a predetermined relatedness score to closely associate said anchored electronic documents.

28. The method of claim 27, wherein said clustering includes tethering together, electronic documents related to an anchored electronic document and having a relatedness scores lower than said predetermined relatedness score to said anchored electronic document to loosely associate said tethered electronic documents with said anchored electronic document.

29. The method of claim 14, further including clustering related electronic documents of said first corpus and said second corpus.

30. The method of claim 29, further including classifying electronic documents under said clusters of related electronic documents.

31. The method of claim 14, wherein said first and second corpora are websites.

32. The method of claim 31, wherein said first and second plurality of electronic documents are webpages of said websites.

33. A computer readable medium with executable instructions for interlinking differing taxonomies comprising:
instructions for accessing a first corpus having a first plurality of electronic documents categorized in accordance with a first taxonomy with a plurality of nodes;
instructions for accessing a second corpus having a second plurality of electronic documents categorized in accordance with a second taxonomy with a plurality of nodes;
instructions for analyzing said nodes of said first taxonomy, said nodes of said second taxonomy, and at least one of said first plurality of electronic documents and said second plurality of documents, to identify nodes of said second taxonomy that correspond to nodes of said first taxonomy; and
instructions for interlinking together said identified nodes of said second taxonomy and said identified nodes of said first taxonomy that correspond with each other.

34. The medium of claim 33, further including instructions for generating a interlinked taxonomy structure with links that interlinks said first and second taxonomies together

35. The medium of claim 33, wherein said instructions for analyzing includes instructions for comparing names of said nodes of said first taxonomy to names of said nodes of said second taxonomy to identify related nodes.

36. The medium of claim 33, wherein said instructions for analyzing includes instructions for comparing electronic documents classified in said nodes of said first taxonomy to electronic documents classified in said nodes of said second taxonomy.

37. The medium of claim 36, further including instructions for determining whether electronic documents classified in said nodes of said first taxonomy is present in said nodes of said second taxonomy.

38. The medium of claim 36, further including instructions for determining whether electronic documents classified in said nodes of said second taxonomy is present in said nodes of said first taxonomy.

39. The medium of claim 35, further including instructions for performing semantic resemblance analysis on at least one of said node names of said first and second taxonomies.

40. The medium of claim 39, further including instructions for performing semantic resemblance analysis on at least one of said electronic documents classified under said nodes of said first taxonomy and said electronic documents classified under said nodes of said second taxonomy.

41. The medium of claim 40, wherein instructions for performing semantic resemblance analysis further includes instructions for at least one of:
determining a source of said plurality of electronic documents;
determining a style of said plurality of electronic documents;
determining usage patterns of words in said plurality of electronic documents;
determining semantic use of words in said plurality of electronic documents;
identification of synonomy assertion phrases; and
identification of proper nouns in said plurality of electronic documents.

42. The medium of claim 33, further including instructions for identifying electronic documents from said first and second plurality of electronic documents that are substantially related to each other, and instructions for anchoring them together so that said anchored electronic documents are closely associated to one another.

43. The medium of claim 42, further including instructions for identifying electronic documents from said first an d second plurality of electronic documents that are peripherally related to an anchored electronic document, and instructions for tethering said peripherally related electronic documents to said anchored electronic document so that said tethered electronic documents are loosely associated to said anchored electronic document.

44. The medium of claim 43, wherein instructions for identifying related electronic documents includes instructions for determining relatedness scores between electronic documents of said first and second plurality of electronic documents which is indicative of degree to which identified documents are related to each other.

45. The medium of claim 33, further including instructions for clustering related electronic documents classified under nodes of said first taxonomy, and instructions for clustering related electronic documents classified in under nodes of said second taxonomy.

46. The medium of claim 45, further including instructions for anchoring together related electronic documents classified under nodes of said first taxonomy with said electronic documents classified under nodes of said second taxonomy that have a predetermined relatedness score to closely associate said anchored electronic documents.

47. The medium of claim 46, wherein said instructions for clustering includes tethering together, electronic documents related to an anchored electronic document and, having a relatedness scores lower than said predetermined relatedness score to said anchored electronic document to loosely associate said tethered electronic documents with said anchored electronic document.

48. The medium of claim 33, further including instructions for clustering related electronic documents of said first corpus and said second corpus.

49. The medium of claim 48, further including instructions for classifying electronic documents under said clusters of related electronic documents.

50. The medium of claim 33, wherein said first and second corpora are websites.

51. The method of claim 50, wherein said first and second plurality of electronic documents are webpages of said websites.
